(19) United States
(12) Patent Application Publication
(10) Pub. No.: US 2018/0231311 A1
(43) Pub. Date: Aug. 16, 2018

(54) METHOD FOR HEAT TREATMENT OF A SHEET STEEL COMPONENT AND HEAT TREATMENT APPARATUS THEREFOR

(71) Applicant: SCHWARTZ GMBH, Simmerath (DE)

(72) Inventors: Frank WILDEN, Simmerath (DE); Jörg WINKEL, Nideggen-Schmidt (DE); Andreas REINARTZ, Monschau (DE)

(21) Appl. No.: 15/751,002

(22) PCT Filed: Aug. 5, 2016
(86) PCT No.: PCT/EP2016/068746

§ 371 Date: Feb. 7, 2018

(30) Foreign Application Priority Data
Aug. 7, 2015 (DE) 10 2015 215 179.4

(51) Int. Cl. F27B 9/06; C21D 1/34; C21D 9/48; C21D 8/04; F27D 11/12

(52) U.S. Cl. CPC F27B 9/066; C21D 1/34; C21D 9/48; F27B 2009/122; F27D 11/12; C21D 2221/00; C21D 8/0405

(57) ABSTRACT

Disclosed are methods and apparatus for impressing a temperature profile onto a sheet steel component, wherein in one or more first areas, a temperature below the AC3 temperature can be impressed on the sheet steel component, and in one or more second areas, a temperature above the AC3 temperature can be impressed on the sheet steel component, and is characterized in that the sheet steel component is firstly preheated in a production furnace, and is then transferred into the thermal re-treatment station, wherein a radiation heat source is moved over the component in the thermal re-treatment station, by means of which the one or more first areas of the sheet steel component can be kept at a temperature below the AC3 temperature or cooled down further, and the one or more second areas can be heated to or kept at a temperature above the AC3 temperature.

The invention relates to a method for the targeted heat treatment of individual component zones of sheet metal components as well as a heat treatment apparatus to execute the method.

In different branches of the technology sector there is the desire for high strength sheet metal components with limited component weight. For example, in the automobile industry there is the ambition to reduce the fuel consumption of motor vehicles and to reduce the CO₂ emissions, while increasing passenger safety at the same time. It is for this reason that a strongly increasing requirement exists for chassis components that have a positive ratio between stability and weight. These components include, in particular, A and B pillars, side impact protection beams in doors, side panels, frame components, bumper holder bracket, cross beam for floor and roof, front and back longitudinal beams. In modern motor vehicles, the raw chassis consists of a safety cage that is usually produced from sheet metal with a stability of approximately 1,500 MPa. The method entails using several AlSi-coated metal plates, in other words metal plates coated with aluminum-silicon. In order to manufacture components made of hardened sheet steel, the press quenching method was developed. The method entails the sheets of steel metal first being heated to an austenite temperature of between 850° C. and 950° C., then being placed in a pressing tool, quickly formed and finally quickly quenched down to a martensite temperature of approximately 250° C. by the water-cooled tool. This creates a hard and stable martensite structure with a stability of approximately 1,500 MPa. This type of hardened steel sheet metal only displays limited elongation at break, which is a disadvantage in specific areas in the event of a collision. The kinetic energy in this case cannot be transformed into deformation heat. In this case, it is actually so that the component will be brittle and break, and this will mean an additional risk of injury for the passengers.

It is therefore desirable on the part of the automobile industry to receive chassis components that consist of several expansion and stability zones within the components in order that very stable areas on the one hand, and very flexible areas on the other are contained in a component. The general requirements of the production system should also continue to be adhered to in this case: this means that no drop-offs in working cycle times of the form hardening system should occur, it should be possible to generally operate the entire system as normal and to quickly reconfigure it to meet specific requirements of individual customers. The method should be robust and economical and the production system should only require a minimum amount of space. The form and edge exactness of the component should be so high that the no hard trimming is required, in order to save substantial amounts of material and working hours.

In order to produce a component with areas of differing hardness and ductility, different types of steel can be welded together so that incurable steel is in the soft and curable steel is in the hard zones. The desired hardness profile across the component can then be achieved in a subsequent curing method. The disadvantages of the method are the occasionally insecure welding seams in the case of the ALSi-coated and approximately 0.8-1.5 mm thick sheet metal that is customarily used for chassis components, the rough hardness transition that exists there, as well as the increased cost of the sheet metal due to the welding as an additional production step. In tests, it occasionally came to downtimes due to breaks near the welding seam, which meant that the method could not be described as being robust. In addition to this, the method has limitations due to the complex geometries involved.

A method is described in the German patent document 10 2007 057 855 B3 in which a formed component in the form of a high strength boron steel separated plate, provided from a strip material having an AlSi coating, is initially heated completely homogeneously to such a temperature and maintained on this temperature level for a certain time so that a diffusion layer is formed as corrosion or scale protection layer, wherein the material from the coating and the base material diffuse with each other. The heating temperature is approximately from 830° C. to 950° C. This homogeneous heating is performed in a first zone having a plurality of temperature zones of a continuous furnace. Following this step, an area of the first type of plate in a second zone of the furnace is cooled down to a temperature at which austenite decomposes. This is takes place at about 550° C. to 700° C. This reduced temperature level is maintained for a certain time, so that the decomposition of austenite takes place completely without any problems. Concurrently with the localized cooling of the area of the first type of plate, in a third zone of the furnace in at least one area of the second type, the temperature is kept so high that in the subsequent hot forging in a corresponding press, sufficient martensite can develop. This temperature is 830° C. to 950° C. When the area of the first type cools, this area of the plate can be briefly brought into contact with cooling jaws.

With this method, it is only possible, however, to carry out only different heat treatments on usually two different areas on relatively simple and large-scale geometries. Complex geometries, such as the arbitrarily formed ductile spot welding edges of a B-column that has otherwise been provided with greater hardness, can be subjected to the corresponding heat treatment using this method. In addition to this, the temperatures of the individual zones in the furnace need to be very exactly regulated, wherein the continuous furnace on the one hand is usually heated with gas burners for economic efficiency reasons, which means, however, that the temperatures of the individual zones cannot be simply and comfortably regulated with the required level of accuracy.

It is known from the Published European Patent Application EP 2 497 840 A1 that a furnace system and method for the targeted heat treatment of individual component zones of sheet metal components exists. The furnace system consists of the customary, universal production furnace for the heating of sheet steel components up to a temperature near, but still below the AC3 temperature, that means the temperature at which the conversion of ferrite to austenite ends, wherein the furnace system, furthermore, consists of a profile furnace with at least one level. The at least one level consists of a top and bottom part, as well as a product specific intermediate flange that has been added in a corresponding holder, wherein the product specific intermediate flange is designed in such a fashion that the component is impressed by a prescribed temperature profile with temperatures above the AC3 temperature for areas to be hardened and below the AC3 temperature for softer areas. The impressing of the temperature profile takes place by means of heat radiation. Because the method prescribes that the components in the production furnace are only heated to a temperature below the AC3 temperature and to introduce the heat for the heating of defined areas to a temperature above the AC3 temperature in a later method step, a very exact temperature regulation in the production furnace is not required, which means that the disadvantage of the poorer regulation of the gas burners compared with electric heating is accepted in favor of the economic feasibility offered by the cheaper energy source that is gas. The disadvantage of this method is that the areas with different temperatures cannot be separated exactly. In addition to this, the exchange of heat via radiation happens relatively slowly, which means that several profile furnaces would need to be operated simultaneously in order to be able to fully use the capacities of the continuous furnace.

From the Published German Patent Application DE 10 2012 102 194 A1 a furnace system and a method for the operation of a furnace system is known, wherein within the furnace system, a radiation heat source is arranged and a metallic component within the furnace system can be thermally treated with two separate temperature ranges. Furthermore, in a second area in the furnace system, an airflow is circulated with which a second temperature range can be used for thermal treatment due to the forced convection. This entails that the first area of the metallic component is heated to at least the AC3 using radiation heat and/or is maintained at least at AC3 and that the second area is cooled by means of convection from at least AC3 temperature down to a temperature below AC3 or that the second area is heated by means of convection to a temperature below AC3, wherein the different temperature zones that arise as a result are kept thermally separate from each other by means of a separator. Keeping the different temperature areas thermally separate from each other is difficult. The separator must be adapted to match the contours of the metallic component in order to effectively keep the different temperature areas thermally separate. This means that the furnace is only then ready for other component geometries after the corresponding modifications have been made, wherein the modifications to the furnace required depend on the size of the furnace, in particular the size of the roller hearth furnace, and are extensive.

In addition to this, it is desirable when an AlSi coating would be created on the component as corrosion protection, and which is securely connected with the component, when the component undergoes heat treatment. This can entail the AlSi being diffused into the surface of the component. This usually takes place at temperatures above 930° C.

All known types of such apparatus require a relatively large amount of space. It is also the case with the known types of such apparatus and methods that it is difficult to apply the heat energy in an exact targeted manner into the different areas of the component. All known types of heat application have the disadvantage that the energy cannot be applied sharply to only specific areas of the component, but adjacent areas are also subjected to heat energy, which means that a sharply separate generation of temperature above the AC3 temperature directly adjacent to areas with temperatures below the AC3 temperature is only possible to a limited extent. In particular, measures in the form of partitions are foreseen in order to be able to maintain hard and ductile component segments directly adjacent to one another following the press quenching.

The object of the invention is to make available a method for the targeted heat treatment of sheet metal components, wherein a demarcation with minimized transition zones between the component areas with temperatures above the AC3 temperatures and component areas with temperatures below the AC3 temperature can be created. A further object of the invention is to make available a heat treatment apparatus for the targeted heat treatment of individual zones of the sheet metal component that requires only a relatively small amount of space, and which makes it possible to achieve a separation between component areas with temperatures above the AC3 temperature and component areas with temperatures below the AC3 temperature without the requirement for isolating measures, wherein the transition zones between the areas are minimized.

In keeping with the object of the invention, this task is completed by means of a method with the characteristics of the independent claim 1. Beneficial further embodiments of the method result from the subclaims 2 to 9. The object of the invention is furthermore fulfilled by means of the heat treatment apparatus according to claim 10. Beneficial further embodiments of the heat treatment apparatus result from the subclaims 11 to 15.

With the inventive method for the impressing of a temperature profile onto a sheet steel component, in one or more first areas, a temperature below the AC3 temperature can be impressed on the sheet steel component, and in one or more second areas, a temperature above the AC3 temperature can be impressed on the sheet steel component. The AC3 temperature, like the recrystallization temperature depends on the alloy. In the case of materials usually used for vehicle chassis construction components, the AC3 temperature is approximately 870° C., while the recrystallization temperature at which the ferrite-perlite structure sets in, is approximately 800° C. The method is characterized in that the sheet steel component is firstly preheated in a production furnace, the sheet steel component is then transferred into a thermal re-treatment station, wherein a radiation heat source is moved over the component in the thermal re-treatment station, by means of which the one or more first areas of the sheet steel component are optionally kept at a temperature below the AC3 temperature or are cooled down further and the one or more second areas of the sheet steel component are optionally heated to or kept at a temperature above the AC3 temperature. During the preheating the component can be heated up to a temperature either above or below the AC3 temperature. Depending on the temperature that exists in the component when the component enters the re-treatment station, in the re-treatment station the one or more first areas of the sheet steel component are kept at a temperature below the AC3 temperature or are further cooled down and the one or more second areas of the sheet steel component are heated to a temperature above the AC3 temperature, as long as they have a lower temperature when entering the re-treatment station or are kept at a temperature above the AC3 temperature, as long as they already had this temperature when entering the re-treatment station. Natural convection, for example, can be used for cooling. Forced convection by means of blowing onto the corresponding part of the component is also possible. The blowing onto the component can happen either from above, meaning the side of the component facing the radiation heat source, or from below, meaning the side of the component facing away from the radiation heat source. It is also conceivable that a contact cooling from underneath the component can also be employed, meaning the side of the component facing away from the radiation heat source.

The production furnace does not require adjustment to the geometry of the sheet steel component to be treated in the case of the method that is the object of the invention, in particular, no separator apparatus must be planned for that depends on the geometry of the component. In contrast, a standard furnace can be used that must not be retrofitted at a production changeover. A standard roller hearth furnace in particular can be used, or a batch furnace. Continuous furnaces usually have a large capacity and are particularly suitable for mass production because they can be loaded and operated without much effort being required. The production furnace can be heated with gas or electrically. Heating with gas is usually the most economically efficient way to heat a production furnace. The regulation of the furnace temperature does not represent increased quality requirements because the entire sheet steel component is heated to an essentially uniform temperature.

The radiation heat sources can be moved over the component. In one embodiment, the radiation heat source is swivel-mounted, for example it can be predominantly swiveled horizontally, in the re-treatment station and it can be swiveled over the component and then swiveled away once again. This allows the component to be easily grabbed by means of a handling apparatus, for example an industrial robot, following completed heat treatment and then be transported further, without the movement disturbing the radiation heat source.

It has shown itself to be beneficial when the re-treatment station is connected directly with the production furnace. The production furnace can be a roller hearth furnace, for example. In a roller hearth furnace, the components are transported through the furnace with rollers. The re-treatment station can be connected directly to the furnace by correspondingly increasing the length of the roller conveyor. A possible effect of this arrangement is, for example, that a component only cools as little as possible in the surrounding air there. It is also possible to connect several re-treatment stations to the furnace in order to minimize the cycle times.

The production furnace can be heated by means of gas burners, for example. Every other form of heating is conceivable and is comprised by the invention.

In a beneficial embodiment, the radiation heat source is a field with surface emitters, so-called VCSELs (Vertical Cavity Surface Emitting Laser), which sends out radiation in the infrared spectrum. Such a field consists of a variety, typically several thousand, of very small lasers (microlasers) with diameters in the pm range, which are arranged with a typically and approximately 40 μm gap between the individual lasers in the field. Such VCSELs provide a radiation that has a far narrower line width and an extremely forward directed beam characteristic compared with infrared LEDs. This makes it possible to impress different temperatures onto a substrate very edge-exactly. Furthermore, very high power densities of 100 W/cm² onto the irradiated surfaces are achieved with this micro-laser technology.

In a beneficial embodiment, the surface emitters emit radiation in the near infrared spectrum between 780 nm and 3 μm, for example radiation in wavelengths of 808 nm or 980 nm.

It has furthermore proven itself beneficial when the surface emitters can be controlled in groups. Alternatively, the surface emitters can also be controlled individually. Mixed forms are also possible, wherein individual surface emitters and other surface emitters can be controlled together in groups.

By manipulating individual emitters or groups of surface emitters it is possible to generate different radiation intensities and so impress a temperature profile onto a substrate. The surface emitters that are located over the first areas of the component, for example, can be manipulated so that they radiate with less power as the surface emitters that are located over the second areas of the component. It is also possible to adapt the radiation power to a three-dimensional component profile by, for example, the areas of the component that are closer to the surface emitters being irradiated with less power than the component areas that are located farther away from the surface emitters due to the three-dimensional geometry of the component. If the surface emitters are pulsed lasers, the manipulation, for example, can refer to the pulse lengths and/or the frequency. What the manipulation entails is determined by what temperature should be reached in each of the individual areas. Here the corresponding temperature, for example the AC3 temperature, depends on the alloy. A further parameter for the manipulation can be the thermal conductivity of the substrate, which is also dependent on the alloy.

In a particularly beneficial embodiment, the production furnace comprises several zones with varying temperatures, wherein the sheet steel component in a first zone or in one of the first zones is heated to a temperature above approximately 900° C., and wherein it cools down so much in the following zones in the through flow direction that it comprises a temperature of less than approximately 900° C., for example approximately 600° C., when it is transferred to the re-treatment station. This can entail, for example, that in the first zone or in the first zones an AlSi coat is diffused into the component and the component is subsequently allowed to cool so much that a perlite-ferrite structure is created. During this in the re-treatment station, the second areas of the component can be very quickly heated back up to temperatures above the AC3 temperature once again via the surface emitter field in order that an austenitic structure can be created in these areas.

A heat treatment apparatus corresponding with the object of the invention consists of a production furnace for the preheating of a sheet steel component and a thermal re-treatment station for the purpose of impressing a temperature profile onto the sheet steel component and is characterized in that the re-treatment station consists of a radiation heat source, wherein the radiation heat source consists of a field with surface emitters from which radiation in the infrared spectrum is emitted.

With the inventive method and the inventive heat-treatment apparatus sheet steel components with several first and/or second areas, which can also be complexly shaped, can be impressed with a corresponding temperature profile in an economically efficient fashion because the surface emitters installed in the re-treatment station allow for a more precise separate treatment of the first and second areas of the sheet steel component as is possible in a production furnace.

Further benefits, particularities and purposeful further developments of the invention result from the subclaims and the following illustration of the preferred embodiment examples by means of the figures.

In the figures:

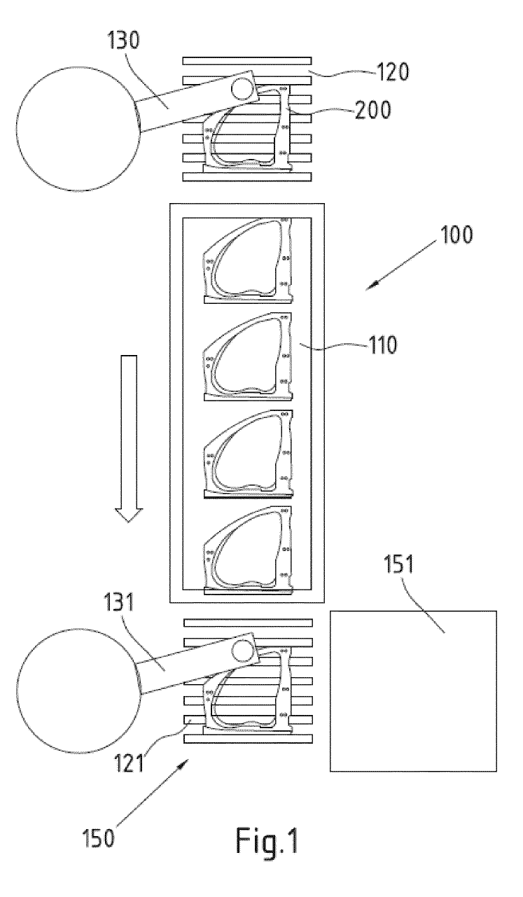

FIG. 1 shows a top view of a heat treatment apparatus corresponding with the object of the invention

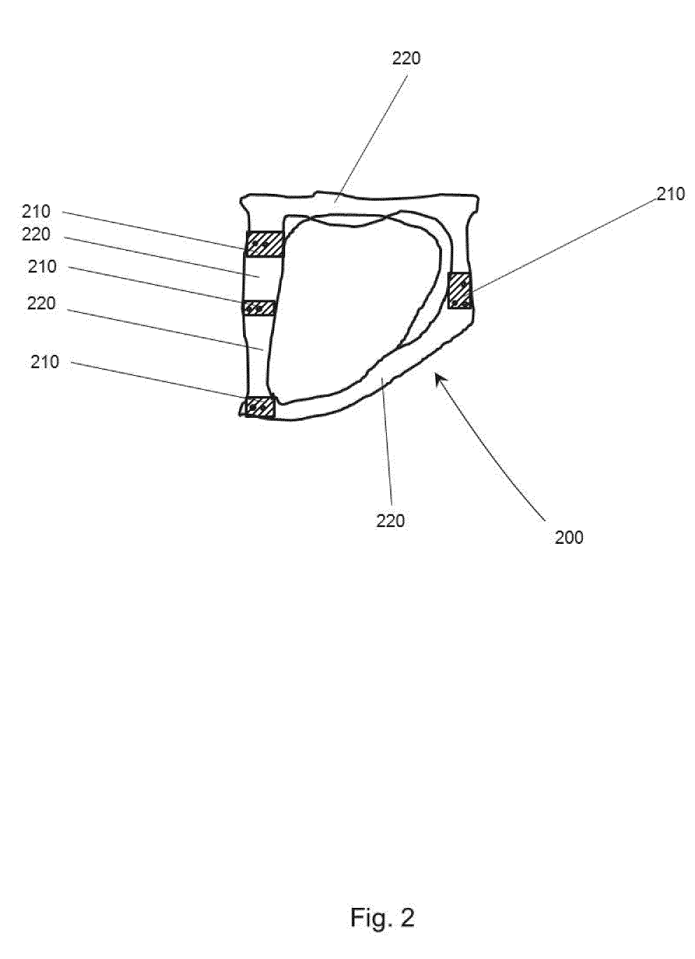

FIG. 2 shows a top view of a sheet steel component with first and second areas

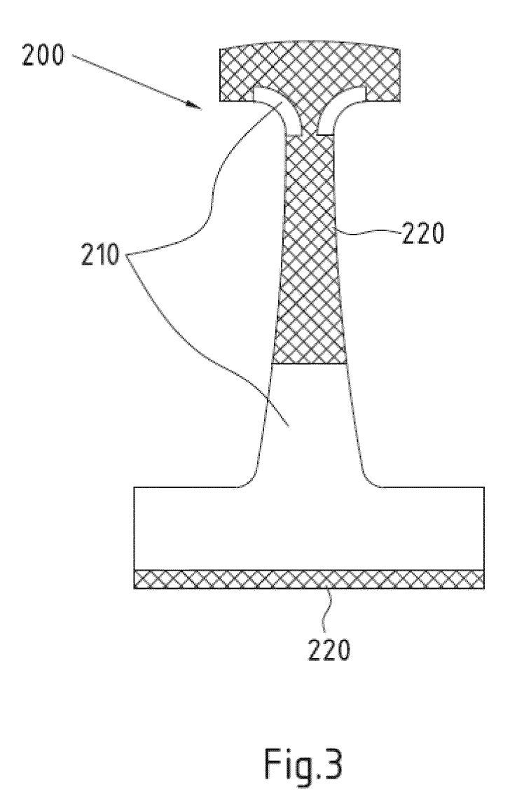

FIG. 3 shows a top view of an example of another sheet steel component following execution of the method that is the object of the invention

FIG. 1 shows a top view of the heat treatment apparatus 100 corresponding with the object of the invention. A sheet steel component 200 is taken from an initial handling apparatus 130 and laid down ready onto an inflow table 120 of the heat treatment apparatus 100. From the inflow table 120, the sheet steel components 200 are conveyed into the production furnace 110 that is designed as a continuous furnace and go through in the arrow direction, wherein their temperature is increased to a temperature above the AC3 temperature, for example. Behind the production furnace 110 when viewed from the through flow direction is an outflow table 121 designed as a re-treatment station 150, onto which the heated sheet steel components 200 are conveyed after going through the production furnace 110. The re-treatment station 150 consists of a radiation heat source 151 in the form of a surface radiator with a field of surface emitters. The radiation heat source 151 is swivellably mounted. The situation is illustrated in the figure in which the sheet steel component 200 was already impressed with the temperature profile. The radiation heat source 151 was also moved over the sheet steel component 200 so that the infrared radiation could hit the sheet steel component. Following the application of the temperature profile, the radiation heat source is now moved away from the sheet steel component 200 so that a second handling apparatus 131 can grab the sheet steel component 200 and transport it further without the movement disturbing the radiation heat source 151.

More thermal re-treatment stations 150 could also be planned. The number of thermal re-treatment stations 150 that should be planned to be beneficial depends on the ratio of the cycle times of production furnace 110 and the thermal re-treatment station 150, wherein the cycle times depend on the temperatures reached and, as a result, among other factors, on the material being processed, as well as the geometry and the thickness of the sheet steel component 200.

FIG. 2 shows a top view of a sheet steel component 200 with first areas 210 and second areas 220. The first areas 210 should demonstrate a high ductility in the later prefabricated component. If this sheet steel component 200 is a vehicle chassis component, these first areas 210 could, for example, refer to those areas where the later prefabricated component is connected to the rest of the vehicle chassis. With respect to the second areas 220 of the sheet steel component 200, the prefabricated component should instead later have high hardness.

FIG. 3 shows a top view of an example of another sheet steel component 200, here a B-column 200 for vehicles following execution of the method that is the object of the invention.

The B-column is the description given to the connection between the vehicle floor and the vehicle roof in the middle of the passenger compartment. The columns in the vehicle, which also includes the B-column as a result, has the life-saving task in the event of an accident and the vehicle overturning, of stabilizing the passenger compartment against vertical deformation. Much more important is the absorption of the forces of side impacts in order that the passengers in the vehicle remain uninjured. In order to be able to ensure that this task is met, the B-column 200 consists of first areas 210 with high ductility and second areas 220 with high hardness. The B-column 200 was applied with the first areas 210 and the second areas 220 by means of the method that is the object of the invention in the heat treatment apparatus that is the object of the invention, wherein the second areas 220 are also additionally tempered.

The embodiments shown here only depict examples for the invention in question and, for that reason, may not be understood to be restrictive. Alternative embodiments taken into consideration by the expert are equally comprised by the protective area of the invention in question.

### LIST OF REFERENCE TERMS

100 Heat treatment apparatus
110 Production furnace
120 Inflow table
121 Outflow table
130 First handling apparatus
131 Second handling apparatus
150 Thermal re-treatment station
151 Radiation heat source
200 Sheet steel component
210 First area
220 Second area
300 Handling apparatus

1. A method for impressing a temperature profile onto a sheet steel component wherein in one or more first areas, a temperature below the AC3 temperature can be impressed on the sheet steel component, and in one or more second areas, a temperature above the AC3 temperature can be impressed on the sheet steel component, characterized in that the sheet steel component is firstly preheated in a production furnace, the sheet steel component is then transferred into a thermal re-treatment station, wherein a radiation heat source is moved over the component in the thermal re-treatment station, by means of which the one or more first areas of the sheet steel component can optionally be kept at a temperature below the AC3 temperature or cooled down further, and the one or more second areas of the sheet steel component can optionally be heated to or kept at a temperature above the AC3 temperature.

2. The method according to claim 1, characterized in that the radiation heat source is a field with surface emitters that emit the radiation in the infrared spectrum.

3. The method according to claim 2, characterized in that the surface emitters emit radiation in the near infrared spectrum between 780 nm and 3 μm.

4. The method according to claim 2, characterized in that the surface emitters can be controlled in groups.

5. The method according to claim 2, characterized in that the surface emitters can be controlled individually.

6. The method according to claim 2, characterized in that the sheet steel component is heated in the production furnace to a temperature below the AC3 temperature.

7. The method according to claim 1, characterized in that the sheet steel component is heated in the production furnace to a temperature above the AC3 temperature.

8. The method according to claim 1, characterized in that the production furnace consists of several zones with different temperatures, wherein the sheet steel component in a first zone or in several first zones is heated to a temperature above approximately 900° C., and wherein it cools down so much in the following zones in the through flow direction that it comprises a temperature of less than approximately 900° C. when it is transferred to the re-treatment station.

9. The method according to claim 8, characterized in that the sheet steel component in a first zone or in the zones that follow the first zones in the through flow direction have cooled down so much that they have a temperature of 600° C. when they are transferred to the re-treatment station.

10. Heat treatment apparatus, consisting of a production furnace for preheating a sheet steel component and a thermal re-treatment station for the impressing of a temperature profile onto the sheet steel component, characterized in that the re-treatment station consists of a radiation heat source, wherein the radiation heat source consists of a field with surface emitters, from which the radiation is emitted in the infrared spectrum.

11. Heat treatment apparatus according to claim 10, characterized in that radiation emitted by the surface emitters is in the near infrared spectrum.

12. Heat treatment apparatus according to claim 10, characterized in that the surface emitters can be controlled in groups.

13. Heat treatment apparatus according to claim 10, characterized in that the surface emitters can be controlled individually.

14. Heat treatment apparatus according to claim 10, characterized in that the re-treatment station (150) is connected directly to the production furnace.

15. Heat treatment apparatus according to claim 10, characterized in that the radiation heat source can be swivellably arranged in the re-treatment station.
